(19) United States
(12) Patent Application Publication
(10) Pub. No.: US 2013/0339929 A1
(43) Pub. Date: Dec. 19, 2013

(54) PROGRAM REPAIR

(71) Applicants: Francesco Logozzo, Issaquah, WA (US); Thomas Ball, Mercer Island, WA (US)

(72) Inventors: Francesco Logozzo, Issaquah, WA (US); Thomas Ball, Mercer Island, WA (US)

(73) Assignee: MICROSOFT CORPORATION, Redmond, WA (US)

(21) Appl. No.: 13/517,602

(22) Filed: Jun. 14, 2012

(51) Int. Cl. G06F 9/44

(52) U.S. Cl. 717/124

(57) ABSTRACT

A method and system for repairing a program are provided herein. The method includes statically analyzing a code of a program via a modular program verifier and determining semantic errors within the code of the program based on the static analysis. The method also includes inferring verified repairs to the code of the program based on the semantic errors.

### BACKGROUND

Computers perform a wide variety of tasks by executing computer programs. Source code for a computer program is typically written by one or more developers using some type of integrated development environment (IDE). In many cases, developers are given a set of design instructions, and, using a programming language, draft source code that will implement the functions described in the design specifications. Depending on the nature and scope of the design specifications, as well as any subsequent modifications thereto, the source code for the program can often become lengthy and complex. It is well known that complex source code is likely to contain software bugs, which are errors or faults within the source code that produce incorrect or unexpected results. In some instances, software bugs arise from errors within a program's source code. In other instances, software bugs are created when a compiler, which transforms source code written in a programming language into code written in a computer language, produces incorrect code.

According to current techniques, a static analyzer can be used to detect software bugs within a program. In some cases, the IDE suggests simple syntactic fixes to the user based on the detected syntactic errors within the program, without fixing what the program is effectively doing at runtime. However, the static analyzer usually leaves the problem of repairing the program to the developers. Thus, the developers may manually analyze the source code to determine the locations of particular software bugs, and then manually repair the program by changing the source code such that the software bugs are removed. However, this may be a very time-consuming process.

### SUMMARY

The following presents a simplified summary of the subject innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

An embodiment provides a method for repairing a program. The method includes statically analyzing a code of a program via a modular program verifier and determining semantic errors within the code of the program based on the static analysis. The method also includes inferring verified repairs to the code of the program based on the semantic errors.

Another embodiment provides a system for repairing a program. The system includes a processor that is adapted to execute stored instructions and a system memory. The system memory includes code configured to statically analyze a code of a program, determine semantic errors within the code of the program, and, for each semantic error, generate suggested repairs to the code of the program based on a type of the semantic error.

In addition, another embodiment provides one or more non-transitory, computer-readable storage media for storing computer-readable instructions. The computer-readable instructions provide a program repair system when executed by one or more processing devices. The computer-readable instructions include code configured to statically analyze execution traces within a code of a program and determine failing assertions within any of the execution traces, wherein the failing assertions comprise semantic errors. The computer-readable instructions also include code configured to infer verified repairs to the code of the program for each semantic error.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 is a block diagram of a networking environment in which a system and method for automatically repairing a program may be implemented;

FIG. 2 is a block diagram of a computing environment that may be used to implement a system and method for automatically repairing a program;

FIG. 3 is a block diagram of a system for automatically repairing a program; and

FIG. 4 is a process flow diagram of a method for automatically repairing a program.

### DETAILED DESCRIPTION

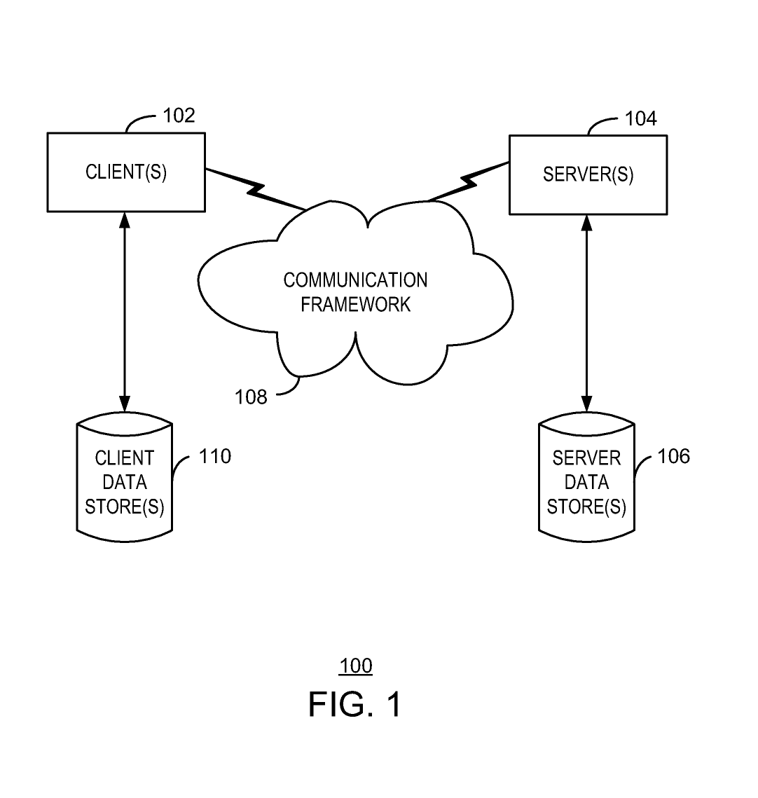

As a preliminary matter, some of the figures describe concepts in the context of one or more structural components, variously referred to as functionality, modules, features, elements, etc. The various components shown in the figures can be implemented in any manner, for example, by software, hardware (e.g., discreet logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 1, discussed below, provides details regarding one system that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, manual processing, and the like, or any combination of these implementations. As used herein, hardware may include computer systems, discreet logic components, such as application specific integrated circuits (ASICs), and the like, as well as any combinations thereof.

As to terminology, the phrase “configured to” encompasses any way that any kind of functionality can be constructed to perform an identified operation. The functionality can be configured to perform an operation using, for instance, software, hardware, firmware and the like, or any combinations thereof.

The term “logic” encompasses any functionality for performing a task. For instance, each operation illustrated in the flowcharts corresponds to logic for performing that operation. An operation can be performed using, for instance, software, hardware, firmware, etc., or any combinations thereof.

As used herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

As used herein, terms “component,” “search engine,” “browser,” “server,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory, computer-readable device, or media. Non-transitory, computer-readable storage media can include, but are not limited to, tangible magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

Overview

As discussed above, computer programs often include software bugs that compromise the proper functioning of the programs. Software bugs may include both syntactic and semantic errors. As used herein, the term “syntax” refers to a set of rules that define the combination of symbols that are considered to be correctly structured code in a particular programming language. Thus, syntactic errors within a computer program may occur when the form of the code is not correct. As used herein, the term “semantics” refers to the meaning of a code written in a particular programming language, as opposed to the form of the code. In other words, the semantics of a programming language provides the rules for interpreting the syntax of a code written in the programming language, since the syntax does not provide the meaning of the code directly but instead constrains the possible interpretations of the code. Thus, semantic errors may occur when the form of the code is correct, but the meaning of the code is not what the developer intended. In some embodiments, a semantic error occurs because one or more of the supplied inputs is an improper input that, when executed, results in an invalid process. For example, if the code included a mathematical division operation, and the input to the denominator was 0, the result of the division operation would be an invalid divide-by-zero process. In this example, the value 0 may be an input to the function, or may be the result of a process that had faulty inputs that led to a 0 being used as the denominator. Such semantic errors are generally not detected by compilers, since compilers are only concerned with the structure, or syntax, of the code, not the meaning. In other words, correct syntax enables compiling of the program, while correct semantics enables proper execution of the program for the intended purpose.

Embodiments described herein set forth a method and system for automatically repairing a program. The method and system described herein use semantic static analysis techniques to detect possible software bugs, e.g., semantic errors, within the code of a particular program. The semantic static analysis techniques may be performed statically, meaning that the techniques may be performed without executing the program. In addition, the method and system described herein may provide for automatic repairing of the program by suggesting one or more code repairs for the possible software bug.

The automatic program repair techniques described herein may be implemented during the development of the program. In various embodiments, code repairs are suggested based on warnings issued by a modular program verifier. The suggested code repairs are property-specific verified repairs. Verified repairs are changes to a program's source code that remove bad execution traces while preserving or increasing the number of good execution traces. A bad execution trace is one that violates a given specification of the original program, such as an assertion, precondition, run-time guard, or the like. A good execution trace is one that meets all specifications of the original program. These two sets of execution traces form a partition of all the traces of a program.

According to embodiments described herein, a modular program verifier uses contracts, e.g., preconditions, post-conditions, object invariants and assumptions, to decompose the verification problem from the level of a whole program to the level of individual methods. Developer-supplied contracts are essential not only for scalability, but also for documenting intent as well as localizing the cause of failures.

The modular program verifier described herein may be an abstract interpreter or any other type of static analyzer. The modular program verifier may be used to generate repairs for contract violations and runtime errors. More specifically, the modular program verifier may be used to generate repairs for missing contracts, e.g., missing preconditions, post-conditions, object invariants, or assumptions, as well as incorrect initialization and conditionals, e.g., wrong constraints or buffer sizes, guards, e.g., negation, strengthening, or weakening, buffer overflows, arithmetic overflows, incorrect floating point comparisons, or the like.

According to the automatic program repair techniques described herein, several abstractions of trace semantics may be defined in order to permit a wide variety of program repairs. One abstraction restricts what is observable about a program state to the program points containing assert expressions, e.g., assertions, which are expressions that are used to debug a program by testing whether an expression within the program contains an error. A Boolean abstraction further restricts the observations to the Boolean values of assertions, which permits changes to program variables appearing in the program and the assertion itself. Based on this semantic foundation, different algorithms for code repairs may be generated.

Computing Environment

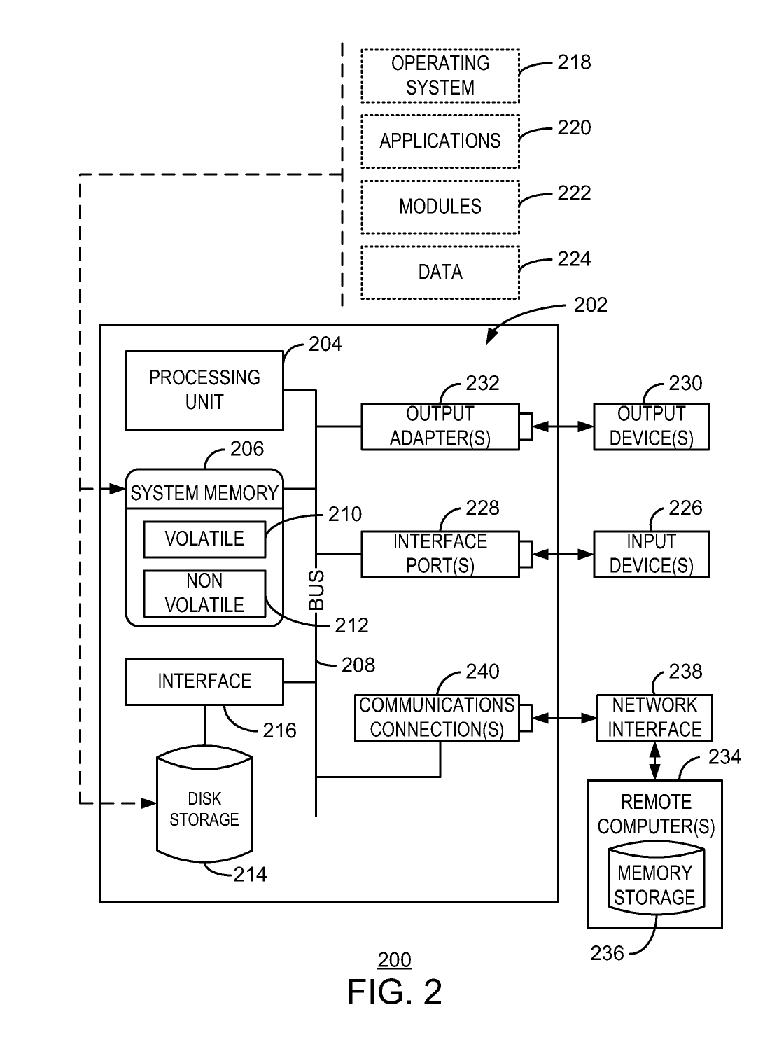

In order to provide context for implementing various aspects of the claimed subject matter, FIGS. 1-2 and the following discussion are intended to provide a brief, general description of a computing environment in which the various aspects of the subject innovation may be implemented. For example, a method and system for automatically repairing a program can be implemented in such a computing environment. While the claimed subject matter has been described above in the general context of computer-executable instructions of a computer program that runs on a local computer or remote computer, those of skill in the art will recognize that the subject innovation also may be implemented in combination with other program modules. Generally, program modules include routines, programs, components, data structures, etc., that perform particular tasks or implement particular abstract data types.

Moreover, those of skill in the art will appreciate that the subject innovation may be practiced with other computer system configurations, including single-processor or multi-processor computer systems, minicomputers, mainframe computers, as well as personal computers, hand-held computing devices, microprocessor-based or programmable consumer electronics, and the like, each of which may operatively communicate with one or more associated devices. The illustrated aspects of the claimed subject matter may also be practiced in distributed computing environments wherein certain tasks are performed by remote processing devices that are linked through a communications network. However, some, if not all, aspects of the subject innovation may be practiced on stand-alone computers. In a distributed computing environment, program modules may be located in local or remote memory storage devices.

FIG. 1 is a block diagram of a networking environment 100 in which a system and method for automatically repairing a program may be implemented. The networking environment 100 includes one or more client(s) 102. The client(s) 102 can be hardware and/or software (e.g., threads, processes, or computing devices). The networking environment 100 also includes one or more server(s) 104. The server(s) 104 can be hardware and/or software (e.g., threads, processes, or computing devices). The servers 104 can house threads to perform search operations by employing the subject innovation, for example.

One possible communication between a client 102 and a server 104 can be in the form of a data packet adapted to be transmitted between two or more computer processes. The networking environment 100 includes a communication framework 108 that can be employed to facilitate communications between the client(s) 102 and the server(s) 104. The client(s) 102 are operably connected to one or more client data store(s) 110 that can be employed to store information local to the client(s) 102. The client data store(s) 110 may be stored in the client(s) 102, or may be located remotely, such as in a cloud server. Similarly, the server(s) 104 are operably connected to one or more server data store(s) 106 that can be employed to store information local to the servers 104.

FIG. 2 is a block diagram of a computing environment 200 that may be used to implement a system and method for automatically repairing a program. The computing environment 200 includes a computer 202. The computer 202 includes a processing unit 204, a system memory 206, and a system bus 208. The system bus 208 couples system components including, but not limited to, the system memory 206 to the processing unit 204. The processing unit 204 can be any of various available processors. Dual microprocessors and other multiprocessor architectures also can be employed as the processing unit 204.

The system bus 208 can be any of several types of bus structures, including the memory bus or memory controller, a peripheral bus or external bus, or a local bus using any variety of available bus architectures known to those of ordinary skill in the art. The system memory 206 is non-transitory, computer-readable media that includes volatile memory 210 and non-volatile memory 212. The basic input/output system (BIOS), containing the basic routines to transfer information between elements within the computer 202, such as during start-up, is stored in non-volatile memory 212. By way of illustration, and not limitation, non-volatile memory 212 can include read-only memory (ROM), programmable ROM (PROM), electrically-programmable ROM (EPROM), electrically-erasable programmable ROM (EEPROM), or flash memory.

Volatile memory 210 includes random access memory (RAM), which acts as external cache memory. By way of illustration and not limitation, RAM is available in many forms, such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 202 also includes other non-transitory, computer-readable media, such as removable/non-removable, volatile/non-volatile computer storage media. FIG. 2 shows, for example, a disk storage 214. Disk storage 214 includes, but is not limited to, devices like a magnetic disk drive, floppy disk drive, tape drive, Jaz drive, Zip drive, LS-100 drive, flash memory card, or memory stick.

In addition, disk storage 214 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 214 to the system bus 208, a removable or non-removable interface is typically used, such as interface 216.

It is to be appreciated that FIG. 2 describes software that acts as an intermediary between users and the basic computer resources described in the computing environment 200. Such software includes an operating system 218. The operating system 218, which can be stored on disk storage 214, acts to control and allocate resources of the computer 202.

System applications 220 take advantage of the management of resources by the operating system 218 through program modules 222 and program data 224 stored either in system memory 206 or on disk storage 214. It is to be appreciated that the claimed subject matter can be implemented with various operating systems or combinations of operating systems.

A user enters commands or information into the computer 202 through input devices 226. Input devices 226 include, but are not limited to, a pointing device (such as a mouse, trackball, stylus, or the like), a keyboard, a microphone, a joystick, a satellite dish, a scanner, a TV tuner card, a digital camera, a digital video camera, a web camera, or the like. The input devices 226 connect to the processing unit 204 through the system bus 208 via interface port(s) 228. Interface port(s) 228 include, for example, a serial port, a parallel port, a game port, and a universal serial bus (USB). Output device(s) 230 may also use the same types of ports as input device(s) 226. Thus, for example, a USB port may be used to provide input to the computer 202 and to output information from the computer 202 to an output device 230.

An output adapter 232 is provided to illustrate that there are some output devices 230 like monitors, speakers, and printers, among other output devices 230, which are accessible via the output adapters 232. The output adapters 232 include, by way of illustration and not limitation, video and sound cards that provide a means of connection between the output device 230 and the system bus 208. It can be noted that other devices and/or systems of devices provide both input and output capabilities, such as remote computer(s) 234.

The computer 202 can be a server in a networking environment, such as the networking environment 100, using logical connections to one or more remote computers, such as remote computer(s) 234. The remote computer(s) 234 may be client systems configured with web browsers, PC applications, mobile phone applications, and the like. The remote computer(s) 234 can be a personal computer, a server, a router, a network PC, a workstation, a microprocessor based appliance, a mobile phone, a peer device or other common network node and the like, and typically includes many or all of the elements described relative to the computer 202. For purposes of brevity, the remote computer(s) 234 is illustrated with a memory storage device 236. Remote computer(s) 234 is logically connected to the computer 202 through a network interface 238 and then physically connected via a communication connection 240.

Network interface 238 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 240 refers to the hardware/software employed to connect the network interface 238 to the system bus 208. While communication connection 240 is shown for illustrative clarity inside computer 202, it can also be external to the computer 202. The hardware/software for connection to the network interface 238 may include, for example, internal and external technologies such as mobile phone switches, modems including regular telephone grade modems, cable modems and DSL modems, ISDN adapters, and Ethernet cards.

Types of Program Repairs

The automatic program repair techniques described herein may be used to implement any of a number of different types of program repairs. For example, in some cases, the code of a method is correct only when executed under certain conditions. In such cases, a program repair may be performed to introduce a contract including appropriate preconditions and/or post-conditions. As shown in the following code fragment, when a parameter is null, there will be a failure due to a null deference of the parameter.

```
void P(int[ ] a)
{
  for (var i = 0; I < a.Length; i++)
    a[i − 1] = 110;
}
```

In this case, the modular program verifier may suggest the precondition a!=null using a contract, as shown in the code fragment below.

```
void P’(int[ ] a)
{
  Contract.Requires(a! = null);
  for (var i = 0; I < a.Length; i++)
    a[i − 1] = 110;
}
```

The following code fragment is an example of an array with a negative length, which will result in the failure of array allocation.

```
int[ ] ContractRepairs(int index)
{
  var length = GetALength( ); // (1)
  var arr = new int[length];
  arr[index] = 9876;
  return arr;
}
```

In this case, there are two possible repairs, namely, an explicit assumption 0<=length may be added, or the post-condition to GetALength may be added and may be set to return a non-negative value. The modular program verifier may suggest both to the programmer, and may allow the programmer to choose which one to apply. The first repair is useful when GetALength is a third-party or external code, as it makes the programmer assumption explicit and prevents the modular program verifier from generating a warning. The second repair documents the behavior of GetALength, clearly stating the contract that can be relied upon by clients of the method. In this example, both a buffer underflow and a buffer overflow are possible. The modular program verifier may propose the precondition 0<=index and the assumption Assume(index<length), making explicit the relationship between the return value of GetALength and the parameter index.

Another type of program repairs arises from improper initialization of variables, such as loop induction variable, or use of constraints just outside a safe zone, e.g., off-by-one errors. The following code fragment is an example of a buffer overflow, which occurs at (*).

```
string GetString(string key)
{
  var str = GetString(key, null);
  if (str == null)
  {
    var args = new object[1];
    args[1] = key; // (*)
    throw new ApplicationException(args);
  }
  return str:
}
```

The modular program verifier may detect the buffer overflow and suggest two potential repairs, namely, allocating a buffer of length at least 2 or using 0 to index the array to avoid buffer overflow without introducing an underflow.

A program repair may also be performed to repair guards of conditional statements. The following code fragment, taken from the .NET framework libraries, is an example of a code fragment that may be corrected by this type of repair.

```
void ValidateOwnerDrawRegions(ComboBox c, Rectangle
updateRegionBox)
{
  if (c == null)
  {
    var r = new Rectangle(0, 0, c.Width); // (*)
    // use r and c
  }
}
```

At point (*), c!=null holds. Otherwise, the program will crash with a null-pointer exception. The modular program verifier may determine that c is null for all the executions reaching that point, e.g., a definite error. Then, the modular program verifier may suggest two repairs, which include either introducing the precondition c!=null or flipping the guard from c==null to c!=null. Thus, neither repair removes any good execution traces present in the original program but, rather, remove bad execution traces. As another example, for the following code fragment, the modular program verifier may suggest to strengthen the if-guard to the condition callA.Length<=num. Otherwise, a buffer overflow may happen.

```
IMethodCallMessage ReadArray(object[ ] callA, object handlerObject)
{
  if (callA == null) return null;
  var num = 0;
  if (NonDet ( )) num++;
  if (callA.Length < num) throw new SerializationException( );
  // here callA.Length >= num
  this.args = (object[ ]) callA[num++];
    // ...
}
```

A program repair may be performed to repair erroneous floating point comparisons that produce unexpected results. The .NET semantics enforces the runtime to use a precise floating point representation for stack values and the representation exactly matching the nominal type for heap values. In the following code fragment, the parameter d0 may be a very small, non-zero double represented by 80 bits on x86. The test succeeds, but the next assignment causes the truncation of the value of d0 to a 64-bit quantity that may be zero, violating the object invariant.

```
class FloatingPoint
{
  double d;
  [ContractInvariantMethod]
  void ObjectInvariant( )
  {
    Contract.Invariant(this.d != 0.0);
  }
  public void Set(double d0)
  {
    // here d0 may have extended double precision
    if (d0 != 0.0)
      this.d = d0; // d0 can be truncated to 0.0
  }
}
```

The modular program verifier may identify this error and suggest repairing the guard to (double)d0!=0.0, i.e., forcing the comparison of the 64-bit truncation of d0 to zero.

In addition, program repairs may be performed to repair overflow expressions, e.g., unintended arithmetic overflows. The following code fragment shows a classical binary search in which the expression at (*) may overflow, setting index to a negative value and resulting in a buffer overflow in the next line.

```
int BinarySearch(int[ ] array, int value)
{
  Contract.Requires(array != null);
  int inf = 0, sup = array.Length − 1;
  while (inf <= sup)
  {
    var index = (inf + sup) /2; // (*)
    var mid = array[index];
    if (value == mid) return index;
    if (mid < value) inf = index + 1; else sup = index − 1;
  }
  return −1;
}
```

In this case, the modular program verifier may suggest repairing the expression to inf+(sup−inf)/2, which: allows more good execution runs and is based on the loop invariant automatically discovered by the modular program verifier, 0≦inf≦sup<array.Length.

In the following code fragment, count can be a very large positive value, causing count+destIndex to overflow.

```
  void ThreadSafeCopy(char* sourcePtr, char[ ] destination,
  int destinationIndex, int
count)
  {
    if (count > 0)
      if ((destinationIndex > destination.Length)
      || ((count + destinationIndex) > destination.Length))
        throw new ArgumentOutofRangeException( );
        { // ... }
  }
```

The modular program verifier may suggest repairing the expression to count>dest.Length−destIndex.

Automatic Program Repair Architecture

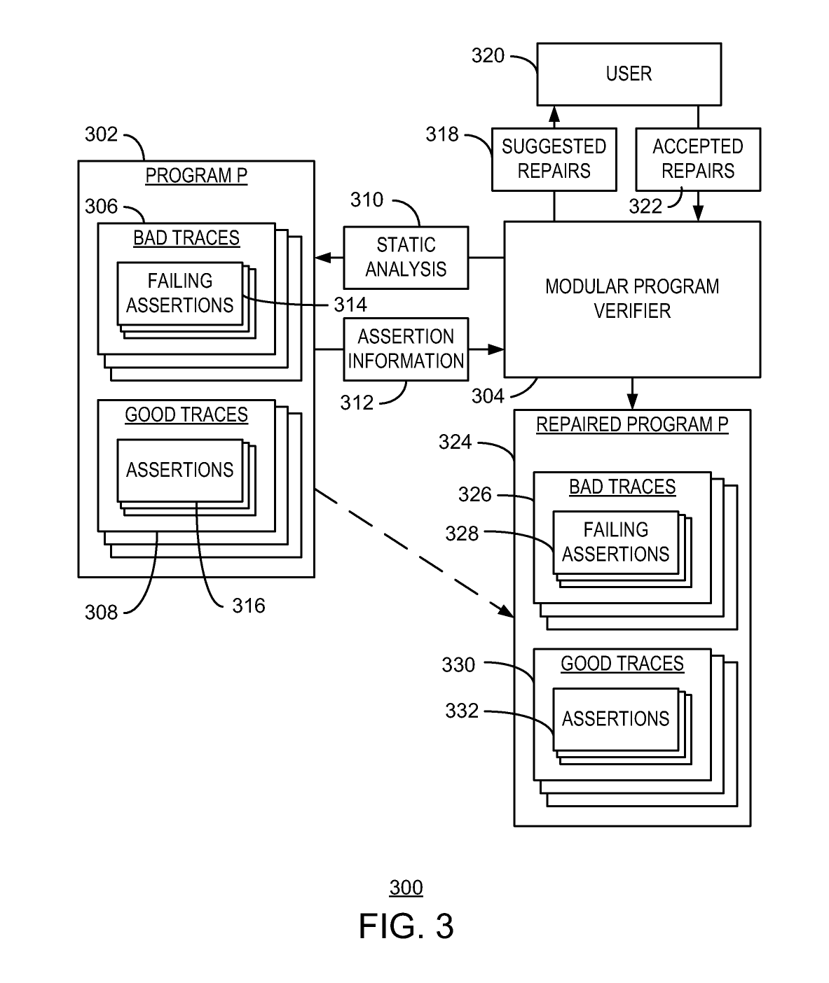

FIG. 3 is a block diagram of an architecture 300 for automatically repairing a program 302. In various embodiments, the architecture 300 is implemented within the networking environment 100 or the computing environment 200, or both. In various embodiments, the architecture 300 repairs the program 302 using a modular program verifier 304. As discussed above, the modular program verifier 304 may be an abstract interpreter or any other type of static analyzer that is capable of performing an automatic program repair procedure.

The program 302 may be denoted by P, and P(pc) may denote the statement at program point pc. P[pc [symbol] S] may denote a program that is the same as P everywhere except pc, where it contains the statement S. If S is a compound statement, a remapping of the program points of S may be performed. Let Σ be a set of states, and τ_{P}∈ [symbol] (Σ×Σ) be a non-deterministic transition relation. For a state s∈Σ, s(C) denotes the basic command associated with the state, e.g., an assignment, an assumption, or an assertion. The set of blocking states, i.e., states with no successors, is [symbol] ={s∈Σ|∀s′. [symbol] τ_{P}(s,s′)}. The set of erroneous states, i.e., states violating some assertion e∈, is [symbol] ={s∈Σ|s(C)=assert e [symbol] σ [symbol] e}⊂ [symbol] .

The program 302 may include a number of bad traces 306 and good traces 308, wherein the traces 306 and 308 are sequences of states. Concatenation is denoted by juxtaposition and extended to sets of traces 306 and 308. Σⁿ denotes the set of non-empty finite traces 306 and 308 s=s₀ . . . s₍ₙ₋₁₎ of length |s|=n≧0, including the empty trace ε of length |ε| [symbol] 0. Σ⁺=∪_{(n≧1)}Σⁿ denotes the set of non-empty finite traces and Σ*=ρ+∪{ε}. The set of finite bad traces 306, i.e., traces containing an error, is [symbol] ={s∈Σ⁺| [symbol] |∈[0, |s|), sᵢ∈ [symbol] }. The bad traces of T⊂Σ* are [symbol] (T) [symbol] T∩ [symbol] , while the good traces are C(T) [symbol] T∩(Σ*\ [symbol] )). The function μ∈ [symbol] (Σ*)→ [symbol] (σ*) filters the maximal traces out of a set of traces 306 or 308.

The partial execution traces or runs are prefix traces generated by applying the transition relation from the initial states until a fixpoint is reached, followed by a projection on the maximal traces, as shown below in Eq. 1.

τₚ⁺(S)=μ(lfpλT,S∪{σ₀ . . . σₙσₙ₊₁|σ₀ . . . σₙ∈T [symbol] τ(σₙ,σₙ₊₁)}) (1)

The bad finite complete runs, or simply bad runs, of the program 302 are [symbol] _{P} [symbol] [symbol] (τ_{P}⁺). Similarly, the good finite complete runs, or simply good runs, of the program 302 are [symbol] _{P} [symbol] [symbol] (τ_{P}⁺).

In various embodiments, the modular program verifier 304 performs a static analysis procedure 310 to determine assertion information 312 relating to the bad traces 306 and the good traces 308. The bad traces 306 may include a number of failing assertions 314, while the good traces 308 may only include correct assertions 316. A failing assertion 314 within a bad trace 306 may indicate that the bad trace 306 includes at least one software bug.

The modular program verifier 304 may use the assertion information 312 to determine suggested repairs 318 for the program 302. The modular program verifier 304 may send the suggested repairs 318 to a user 320 via a graphical interface of a computing system in which the program 302 and the modular program verifier 304 reside. The user 320 may then indicate a number of accepted repairs 322 via a pointing device, for example, of the computing system.

Based on the accepted repairs 322, the modular program verifier 304 may repair the program 302 to generate a new, repaired program 324, denoted by P′. The repaired program 324 may include a number of bad traces 326 with failing assertions 328 and a number of good traces 330 with correct assertions 332. However, the repaired program 324 may include fewer bad traces than the program 302, and may include at least as many good traces as the program 302. For example, in some embodiments, the repaired program 324 does not include any bad traces 326, or only includes new bad traces 326, which may be repaired in a subsequent program repair procedure.

In various embodiments, because a repair may change the control flow of the program 302, introducing new states and possibly new assertions, the concrete traces of the program 302 and the repaired program 324 may appear very different. In many cases, the simple inclusions [symbol] _{P′}⊃ [symbol] _{P} and [symbol] _{P′}⊂ [symbol] _{P} may be too strict and may hold only for trivial repairs. Therefore, the semantics of the program 302 and the repaired program 324 may be compared at a higher level of abstraction. This may be accomplished by removing all states except those containing assertion statements and removing all new assertions introduced in the repaired program 324. As discussed further below, abstract interpretation provides the right framework to formalize this technique.

As used with relation to abstract interpretation, a Galois connection [symbol] L,≦ [symbol] α⇄γ [symbol] L̅, [symbol] [symbol] consists of posets [symbol] L, [symbol] [symbol] L̅, [symbol] [symbol] and maps α∈L→ L̅, γ∈ L̅→L such that ∀x∈L, y∈ L̅:α(x) [symbol] y [symbol] xγ(y). In a Galois connection, the abstraction a preserves existing least upper bounds and, hence, is monotonically increasing. By duality, the concretization γ preserves existing greatest lower bounds and is monotonically increasing. The composition of Galois connections is a Galois connection.

The assertion abstraction α_{A} removes all states except those referring to assertions. The abstractional α_{A}¹∈Σ⁺→Σ* on a single trace is shown below in Eq. 2.

$${α}^{1} A ( s ) = \{ \begin{matrix}ε & s = ε \\ s {α}_{A}^{1} ( {s}^{′} ) & s = {ss}^{′} ⋀ s ( C ) = assert e \\ {α}_{A}^{1} ( {s}^{′} ) & s = {ss}^{′} ⋀ s ( C ) \neq assert e\end{matrix} \qquad ( 2 )$$

This can be lifted to a set of traces α_{A} ∈ [symbol] (Σ*)→ [symbol] (Σ*): α_{A}(T)=∪_{s∈T} α_{A}¹(s). The function α_{A} is a complete ∪-morphism. Thus, it exists as a unique concretization γ_{A} such that [symbol] (Σ*), ⊂ [symbol] α_{A}⇄γ_{A} [symbol] (Σ*), ⊂, [symbol] . The assertion trace semantics of the program 302 is α_{A}(τ_{P}⁺).

In general, a repair may introduce new assertions, which may or may not hold. As the goal of a repair is to address the failing assertions 314 of the original program 302, all the new assertions and the new variables may be removed from the assertion semantics of the repaired program 324 before comparing the behaviors of the program 302 and the repaired program 324.

Let δP,P′ denote a repair that transforms the program P 302 to the repaired program P′ 324, and let [symbol] (δ_{P,P′}) be all the new assertions introduced by the repair in the repaired program P′ 324. Let πδ_{_{P,P′}}∈Σ→Σ denote the state projection over all the common variables of the program P 302 and the repaired program P′ 324. As shown below in Eq. 3, the function α_{δ}_{_{P,P′}}¹∈Σ*→Σ* removes all the new assertions and new variables from a trace.

$${α}_{{δ}_{P , {P}^{′}}}^{1} ( s ) = \{ \begin{matrix}ε & s = ε \\ {π}_{{δ}_{P , {P}^{′}}} ( s ) {α}_{{δ}_{P , {P}^{′}}}^{1} ( {s}^{′} ) & s = {ss}^{′} ⋀ s ( C ) ∉ \\ {α}_{{δ}_{P , {P}^{′}}}^{1} ( {s}^{′} ) & s = {ss}^{′} ⋀ s ( C ) = assert e\end{matrix} \qquad ( 3 )$$

In addition, this can be lifted to the sets of traces α_{δP,P′}∈ [symbol] (Σ*)→ [symbol] (Σ*), defined as α_{δ}_{_{P,P′}}(T)=∪_{\vec{s}∈T} α_{δ}_{_{P,P′}}¹(s), is a complete ∪-morphism. Thus, it exists as a concretization function γ_{δ}_{_{P,P′}} such that [symbol] (Σ*), ⊂ [symbol] α_{δ}_{_{P,P′}}⇄γ_{δ}_{_{P,P′}} [symbol] (σ*), ⊂ [symbol] .

According to the information provided above, the concept of a verified repair, as well as the concept of a repaired program, e.g., the repaired program 324, improving another program, e.g., the program 302, may be formally defined. Specifically, if α_{A} ( [symbol] _{P})⊂α_{δ}_{_{P,P′}}∘α_{A}( [symbol] _{P′}) and α_{A}( [symbol] _{P})⊃α_{δ}_{_{P,P′}}, ∘α_{A}( [symbol] _{P′}), then we say that δ_{P,P′} is a verified repair for the program P 302 and that the repaired program P′ 324 is an improvement of the program P 302.

This definition denies the identity, i.e., the program P 302 itself, as a trivial improvement, since the number of bad traces 306 is strictly decreased. It allows for the removal of an always failing assertion 314 as a repair. If an assertion fails in some executions and passes in others, then its removal is disallowed, as the subset inclusion on good runs will fail. For the program P 302, there may be several distinct improvements, e.g., several possible repaired programs 324. The definition of verified repair naturally induces a partial order on programs and, hence, on improvements. Specifically, a program Q improves R, written R [symbol] Q, if δ_{R,Q} is a verified repair for R. The same assertions may be compared over two versions of the program. Therefore, the repaired program P′ 324 may introduce new software bugs, which may be fixed in another program repair process. The program repair process can be iterated to a fixpoint.

According to the definition above, all the assertions are the same, and the variables have the same concrete values. This may be relaxed by introducing a further abstraction at αₜ¹∈Σ→ [symbol] (Σₐ*), Σₐ* [symbol] ε∪{true, false}× [symbol] , as shown below in Eq. 4, which abstracts from a state everything but the assertion and its truth value.

$${α}^{1} ( s ) = \{ \begin{matrix}ε & s = ε \\ \{ 〈 b , e 〉 \} ⋃ {α}_{t}^{1} ( {s}^{′} ) & s = {ss}^{′} ⋀ s ( C ) = assert e \\ & ⋀ b = s = e \\ {α}_{t}^{1} ( {s}^{′} ) & s = {ss}^{′} ⋀ s ( C ) \neq assert e\end{matrix} \qquad ( 4 )$$

The lifting to sets of traces αₜ∈ [symbol] (Σ*)→ [symbol] (Σₐ*), defined as αₜ(T)=∪_{\vec{s}∈T} αₜ¹(s), is a complete ∪-morphism, so that it exists a concretization function γₜ such that [symbol] (Σ*), ⊂ [symbol] αₜ⇄γₜ [symbol] (Σₐ*), ∪ [symbol] .

In addition, if αₜ∘α_{A}( [symbol] _{P})⊂αₜ∘α_{δ}_{_{P,P′}}∘( [symbol] _{P′}) and αₜ∘α_{A}( [symbol] _{P})⊃αₜ∘α_{δP,P′}∘α₄( [symbol] _{P′}), then δ_{P,P′} is a verified assertion repair for the program P 302, and the repaired program P′ 324 is an assertion improvement for the program P 302. Thus, an assertion improvement, i.e., the repaired program P′ 324, focuses on the assertion behavior, ensuring that the repair decreases the number of assertions violated and that no regression is introduced. A verified assertion repair is a weaker concept than verified repair, as it allows the addition of new traces that change the behavior of the program 302, while not breaking the old assertions. A program Q improves R, written R [symbol] ₐ Q, if δ_{R,Q} is a verified assertion repair for R.

In various embodiments, the suggested repairs 318 are verified repairs, which are property-specific. Verified repairs exploit the inferred semantic information and the specification in the form of contracts or runtime errors to automatically produce the suggested repairs 318. The suggested repairs 318 are inferred by leveraging a backwards analysis to propose new contracts, initializations, and guards, as well as a forward analysis to propose repairs for off-by-one errors, floating point comparison errors, and arithmetic overflows.

According to embodiments described herein, the modular program verifier 304 may be an abstract interpretation-based static analyzer in order to generate verified repairs for the program 302. The modular program verifier 304 may perform four main functions, including gathering assertions about the program 302, inferring facts, proving the existence of semantic errors, and reporting warnings and suggesting repairs. In the first phase, the modular program verifier 304 gathers the program assertions, either provided by the programmer or user 320, e.g., as contracts, or by language semantics, e.g., division by zero or a null pointer. Then, the modular program verifier 304 may use abstract interpretation to infer facts about the program 302. The modular program verifier 304 may include abstract domains for heap abstraction, nullness checking, scalable numerical analysis, universally and existentially quantified properties, and floating point comparisons. The modular program verifier 304 may use the inferred facts about the program 302 to discharge the gathered assertions.

The decision procedure of the modular program verifier 304 has four possible outcomes: (i) true, meaning that the assertion holds for all executions reaching it, if any; (ii) false, meaning that every execution reaching the assertion, if any, will cause it to fail; (iii) bottom, meaning that no execution will ever reach the assertion; and (iv) top, meaning that the outcome is unknown because the assertion is violated only sometimes or the analysis was too imprecise. If the outcome is top or false, the modular program verifier 304 may attempt to find a verified repair before reporting the warning or error to the user 320. If one or more verified repairs are found, then the suggested repairs 318 may be reported to the user 320 via a graphical interface, as discussed above. The suggested repairs 318 may be used by the warning scoring algorithm to produce a ranking of the warnings. For instance, a possible arithmetic overflow or buffer overflow that can be repaired may be ranked highly.

A backwards analysis may be used to infer repairs. Specifically, the modular program verifier 304 may implement a goal-directed backward analysis [symbol] _{pc}(e), starting from a failing assertion e within the program 302. For each program point pc, if [symbol] _{pc}(e) does not hold at pc, then e will fail later in the program 302. In general, [symbol] is an under-approximation of the semantics, computing fixpoints when loops are encountered. The modular program verifier 304 may use the analysis [symbol] to suggest repairs by matching [symbol] _{pc}(e) and the statement P(pc), as discussed further below.

In some embodiments, repairs are performed for particular contracts of the program 302. Contracts, including preconditions, post-conditions, object invariants, assertions and assumptions, are used for code documentation. In addition, contracts may be used by the modular program verifier 304 to perform the assume/guarantee reasoning for the automatic program repair process. In various embodiments, the backward analysis procedure may be used to suggest contracts.

The inference of preconditions is a form of verified repair. A candidate precondition is [symbol] _{entry}(e). If [symbol] _{entry}(e) meets the visibility and inheritance constraints of the enclosing method, then it can be suggested as precondition. Otherwise, it is suggested as an assumption. In both cases, P [symbol] [symbol] _{entry}(e); P follows from the fact that [symbol] only produces certain conditions.

It may be the case that the backwards analysis stops at pc≠entry, i.e., before reaching the entry point of the method. For instance, this happens when the variable in the goal expression is the return value from a method. However, a repair can still be suggested. During the repair, no good traces 308 are removed from the program 302, i.e., P [symbol] P[pc [symbol] (P(pc); Assume( [symbol] _{pc}(e)))].

The condition analysis [symbol] (e) can be used to infer repairs for initialization and guards. Let k be a compile-time constant and i=k the statement at the program point pc. If [symbol] _{pc}(e)=i=k′, with k′≠k, then an erroneous initialization has been detected. The repair i=k′: P′ [symbol] P[pc [symbol] (i=k′)] can be suggested. More generally, if the condition is i⋄k′, with ⋄ a relational operator, then i may be initialized to a value satisfying i⋄k′. However, the initialization repair may change the behavior of the program 302, and may cause assertions not in δ_{P,P′} to fail in the repaired program P′ 324. Therefore, to verify the repair before suggesting it to the user 320, the repaired program P′ 324 may be analyzed in the background to check that no additional assertion failures are introduced by the repair, so that P [symbol] ₐ P′.

The condition analysis [symbol] (e) can be used to check whether a guard is too weak, or even contradictory. If, at a program point pc, P(pc)=Assume g, i.e., g is the guard at program point pc, and [symbol] _{pc}(e)=!g, then the modular program verifier 304 may suggest to use !g instead of g, after checking that no new assertion failure is introduced. Similarly, if g [symbol] a<=b and [symbol] _{pc}(e)=a<b, the modular program verifier 304 can suggest a guard strengthening. Therefore, P [symbol] ₐ P[pc [symbol] Assume( [symbol] _{pc}(e))].

In various embodiments, repairs are inferred from abstract domains. For example, repairs to off-by-one errors, floating point comparisons, and arithmetic overflows may be inferred in this manner. In some embodiments, the semantic facts inferred at a given program point can be used to suggest repairs. In particular, the modular program verifier 304 can use the information inferred by the numerical abstract domains to suggest repairs for off-by-one errors. If the modular program verifier 304 cannot prove an assertion a<b at program point pc, but it can prove a<=b, then it can suggest using a−1 instead of a, provided it does not introduce any new warning. In this case, P [symbol] ₐ P[pc [symbol] P(pc)[a [symbol] −1]].

The modular program verifier 304 can also use the information inferred by the numerical abstract domains to suggest repairs for floating point comparisons. The .NET type system allows two kinds of floating point numbers, including Float32, which is 32 bits, and Float64, which is 64 bits. The .NET specification states that floats in locals, e.g., stack locations, parameters, or return values, are to be implemented by the underlying virtual machine with high precision. On the other hand, heap locations, e.g., fields, array elements, or statics, are to match the precision of their nominal type. As a consequence, when a local float is stored into a heap location, the value of the local float is truncated. The comparison of values of different bit sizes may lead to very unexpected results.

For an expression a⋄b at pc, with ⋄ relational operator, if the modular program verifier 304 deduces that one of the operands has an extended precision, while the other has nominal precision, the modular program verifier 304 may suggest the repair t, containing the truncation of the extended precision value to its nominal type.

The modular program verifier 304 can use the information inferred by the numerical abstract domains to suggest repairs for arithmetic overflows. More specifically, an algorithm that leverages the decision procedure and the numerical facts inferred by the abstract domains can be used to repair arithmetic overflows within the program 302. The expressions for the algorithm may be considered in the language shown below in Eqs. 5-8.

e::=a|a⋄a (5)

a::=k|v|a+a|a−a|a/k (6)

⋄::=<|<=|>|>=|==|!= (7)

k::=−2^{p-1}| . . . −1|0|1| . . . 2^{p-1} (8)

The algorithm may be a non-deterministic memorization-based algorithm that is defined by a set of rewriting rules, which are shown below in Eqs. 9-25.

$$\begin{matrix}\overline{{k}^{?} \to {k}^{!}} & ( 9 ) \\ \overline{{v}^{?} \to {v}^{!}} & ( 10 ) \\ \overline{{( {a}_{1}^{!} ⋄ {a}_{2}^{!} )}^{?} \to {( {a}_{1}^{!} ⋄ {a}_{2}^{!} )}^{!}} & ( 11 ) \\ \frac{ok ( {a}_{1} {opa}_{2} ) op ∈ \{ + , - \}}{{( {a}_{1}^{!} {opa}_{2}^{!} )}^{?} \to {( {a}_{1}^{!} {opa}_{2}^{!} )}^{!}} & ( 12 ) \\ ( {( {a}_{1}^{!} - {a}_{2}^{!} )}^{?} ⋄ 0 ) \to {( {a}_{1}^{!} ⋄ {a}_{2}^{!} )}^{!} & ( 13 ) \\ \frac{ok ( - {a}_{2} )}{{( {( {a}_{1}^{!} + {a}_{2}^{!} )}^{?} ⋄ 0 )}^{?} \to {( {a}_{1}^{!} ⋄ - {a}_{2}^{!} )}^{!}} & ( 14 ) \\ \frac{k \neq 0 ⋀ ( a \neq Min Int ⋁ k \neq - 1 )}{{( \frac{{a}^{!}}{{k}^{!}} )}^{?} \to {( \frac{{a}^{!}}{{k}^{!}} )}^{!}} & ( 15 ) \\ {( \frac{{( {a}^{!} + {b}^{!} )}^{?}}{{2}^{!}} )}^{?} \to {( {( {a}^{!} + {( \frac{{( {b}^{!} - {a}^{!} )}^{?}}{{2}^{!}} )}^{!} )}^{!} )}^{!} & ( 16 ) \\ \overline{{( \frac{{( {a}^{!} + {b}^{!} )}^{?}}{{2}^{!}} )}^{?} \to } \overline{{( {( {b}^{!} + {( \frac{{( {a}^{!} - {b}^{!} )}^{?}}{{2}^{!}} )}^{!} )}^{!} )}^{!}} & ( 17 ) \\ \frac{ok ( c - a )}{{( {( {a}^{!} + {b}^{!} )}^{?} ⋄ {c}^{!} )}^{?} \to {( {b}^{!} ⋄ {( {c}^{!} - {a}^{!} )}^{!} )}^{!}} & ( 18 ) \\ \frac{ok ( c - b )}{{( {( {a}^{!} + {b}^{!} )}^{?} ⋄ {c}^{!} )}^{?} \to {( {a}^{!} ⋄ {( {c}^{!} - {b}^{!} )}^{!} )}^{!}} & ( 19 ) \\ \frac{ok ( a - c )}{{( {( {a}^{!} + {b}^{!} )}^{?} - {c}^{!} )}^{?} \to {( {( {a}^{!} - {c}^{!} )}^{!} + {b}^{!} )}^{?}} & ( 20 ) \\ \frac{ok ( b - c )}{{( {( {a}^{!} + {b}^{!} )}^{?} - {c}^{!} )}^{?} \to {( {a}^{!} + {( {b}^{!} - {c}^{!} )}^{!} )}^{?}} & ( 21 ) \\ \frac{ok ( a + b )}{{( {( {a}^{!} - {c}^{!} )}^{!} + {b}^{!} )}^{?} \to {( {( {a}^{!} + {b}^{!} )}^{!} - {c}^{!} )}^{?}} & ( 22 ) \\ \frac{ok ( a + b )}{{( {a}^{!} + {( {b}^{!} - {c}^{!} )}^{?} )}^{?} \to {( {( {a}^{!} + {b}^{!} )}^{!} - {c}^{!} )}^{?}} & ( 23 ) \\ \overline{{( {( {a}^{!} + {b}^{!} )}^{?} ⋄ {c}^{?} )}^{?} \to } \overline{{( {( {( {a}^{!} + {b}^{!} )}^{?} - {c}^{?} )}^{?} ⋄ 0 )}^{?}} & ( 24 ) \\ \overline{{( {( {a}^{!} + {1}^{!} )}^{?} <= {b}^{!} )}^{?} \to } \overline{{( {a}^{!} < {b}^{!} )}^{!}} & ( 25 )\end{matrix}$$

The algorithm starts with an expression a, which may cause an overflow for some input, and rewrites it to an expression a′, which is provably non-overflowing. The algorithm annotates each sub-expression with a tag, including “?,” which means that it is unknown if the expression may overflow, and “!,” which means that the expression is not-overflowing for the values in the concretization of the current abstract state. If it succeeds, the algorithm ensures that a′ evaluates to the same value as a when they are both interpreted over [symbol] . In addition, the algorithm ensures that no overflow happens when evaluated on [symbol] ₚ, where p∈{8, 16, 32, 64 . . . } is the given integer precision.

The algorithm is incomplete by design, for performance reasons. In addition, the algorithm is an abstract interpretation of the trivial algorithm, which enumerates all the equivalent expressions and then checks for non-overflowing. According to the rules above, a constant, a variable, and the comparison of non-overflowing expressions do not overflow. The uncertainty on a binary arithmetic expression can be removed if the underlying abstract state guarantees that the operation does not overflow. Moving the right operand of a subtraction to the right of a comparison operator removes a possible overflow. In the case of an addition, −a does not overflow, i.e., a may be MinInt. Division by a constant overflows if k=0 or if MinInt is divided by −1. Half-sum can be written in two ways. An addition can be traded for a subtraction, or a subtraction can be traded for an addition if the new expression does not overflow. Finally, shuffling expressions may be allowed by moving them on the same side of a relational operator, and strict inequalities may be introduced to remove overflows. Let P′ be such that all the overflowing expressions are replaced by the result of the algorithm above. Then P [symbol] ₐ P′.

The block diagram of FIG. 3 is not intended to indicate that the system 300 is to include all the components shown in FIG. 3. Further, the system 300 may include any number of additional components, depending on the details of the specific implementation. In some embodiments, before sending the suggested repairs 318 to the user 320, the modular program verifier 304 performs a simplification procedure to eliminate any redundant repairs. For example, if x>0 and x>1 are inferred as suggested repairs 318, the modular program verifier 304 may retain only the latter repair. Because several repairs are often generated for one warning, such a simplification procedure may be frequently used to simplify the automatic program repair process.

Method for Automatically Repairing a Program

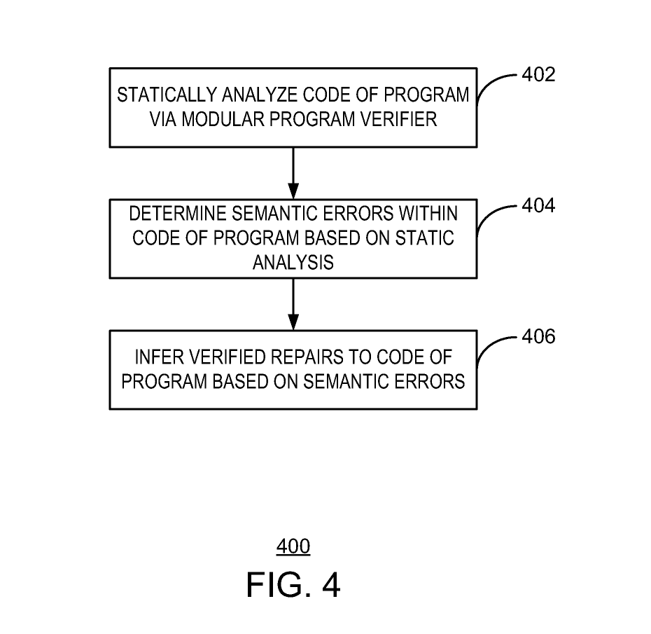

FIG. 4 is a process flow diagram of a method 400 for automatically repairing a program. The method 400 may be implemented by the modular program verifier 304 within the architecture 300 discussed above with respect to FIG. 3. In addition, the method 400 may be implemented within the networking environment 100 and/or the computing environment 200 discussed above with respect to FIGS. 1 and 2, respectively.

The method begins at block 402, at which the code of a program is statically analyzed via the modular program verifier. More specifically, the execution traces within the program code may be analyzed. In various embodiments, the program is analyzed without being executed. For example, the program may be analyzed during the development stage, even if the program has not been completed.

At block 404, semantic errors within the code of the program are determined based on the static analysis. In various embodiments, the semantic errors are failing assertions within particular execution traces. More specifically, the semantic errors may include missing contracts, incorrect initialization and conditionals, buffer overflows, arithmetic overflows, incorrect floating point comparisons, or the like.

At block 406, verified repairs to the code of the program are inferred based on the semantic errors. The modular program verifier may then send the verified repairs to a user of the computing device on which the program resides. In some embodiments, a number of verified repairs are determined for each semantic error, and a user may be allowed to select a particular verified repair to implement for each semantic error.

In some embodiments, the verified repairs are inferred based on the particular types of semantic errors that are identified. For example, a specific template or method may be used to infer verified repairs for contract errors, while a different template or method may be used to infer verified repairs for floating point comparison errors, as discussed above with respect to FIG. 3.

It is to be understood that the method 400 is not intended to indicate that the steps of the method 400 are to be executed in any particular order, or that all of the steps of the method 400 are to be included in every case. Further, any number of additional steps may be included within the method 400, depending on the details of the specific implementation. For example, any of the verified repairs may be implemented by the modular program verifier in response to input from the user. In addition, in some embodiments, the method 400 is also used to infer and repair syntactic errors within the code of the program.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for repairing a program, comprising:
statically analyzing a code of a program via a modular program verifier;
determining semantic errors within the code of the program based on the static analysis; and
inferring verified repairs to the code of the program based on the semantic errors.

2. The method of claim 1, wherein statically analyzing the code of the program comprises analyzing the program without executing the program.

3. The method of claim 1, wherein the method is executed during development of the program.

4. The method of claim 1, comprising implementing any of the verified repairs based on feedback from a user of a computing device on which the program resides.

5. The method of claim 1, wherein determining the semantic errors comprises detecting missing contracts within the code of the program.

6. The method of claim 1, wherein determining the semantic errors comprises detecting incorrect initialization and conditionals within the code of the program.

7. The method of claim 1, wherein determining the semantic errors comprises detecting buffer overflows within the code of the program.

8. The method of claim 1, wherein determining the semantic errors comprises detecting arithmetic overflows within the code of the program.

9. The method of claim 1, wherein determining the semantic errors comprises detecting incorrect floating point comparisons within the code of the program.

10. The method of claim 1, comprising determining a plurality of verified repairs for each semantic error, and comprising allowing a user to select one of the plurality of verified repairs to implement for each semantic error.

11. A system for repairing a program, comprising:
a processor that is adapted to execute stored instructions; and
a system memory, wherein the system memory comprises code configured to:
statically analyze a code of a program;
determine semantic errors within the code of the program; and
for each semantic error, generate suggested repairs to the code of the program based on a type of the semantic error.

12. The system of claim 11, wherein a modular program verifier is configured to statically analyze the code, determine the semantic errors, and generated suggested repairs.

13. The system of claim 11, wherein the system memory comprises code configured to implement one of the suggested repairs for a semantic error in response to input from a user of the system.

14. The system of claim 11, wherein the type of the semantic error comprises a contract error.

15. The system of claim 11, wherein the suggested repairs comprise verified repairs.

16. The system of claim 11, wherein the semantic errors comprise failing assertions within execution traces of the code.

17. One or more non-transitory, computer-readable storage media for storing computer-readable instructions, the computer-readable instructions providing a program repair system when executed by one or more processing devices, the computer-readable instructions comprising code configured to:
statically analyze execution traces within a code of a program;
determine failing assertions within any of the execution traces, wherein the failing assertions comprise semantic errors; and
for each semantic error, infer verified repairs to the code of the program.

18. The one or more non-transitory, computer-readable storage media of claim 17, wherein verified repairs for a semantic error are inferred based on a type of the semantic error.

19. The one or more non-transitory, computer-readable storage media of claim 17, wherein the computer-readable instructions comprise code configured to execute a selected one of the verified repairs for a particular semantic error.

20. The one or more non-transitory, computer-readable storage media of claim 17, wherein the computer-readable instructions comprise code configured to statically analyze the execution traces, determine the failing assertions, and infer the verified repairs without executing the program.
